(19) United States
(12) Patent Application Publication
(10) Pub. No.: US 2012/0004635 A1
(43) Pub. Date: Jan. 5, 2012

(54) METHOD AND MEANS FOR COLLECTING CORD BLOOD

(76) Inventor: Miki Shacham, Tel-Aviv (IL)

(21) Appl. No.: 12/998,653

(22) PCT Filed: Nov. 4, 2009
(86) PCT No.: PCT/IL09/01032

§ 371 Date: May 13, 2011

Related U.S. Application Data
(60) Provisional application No. 61/110,991, filed on Nov. 4, 2008.

(51) Int. Cl. A61J 1/14

(52) U.S. Cl. 604/403

(57) ABSTRACT

The invention is a cord blood open circuit collection system and a method of using a cord blood open circuit collection system to harvest cord blood.

### FIELD OF THE INVENTION

The invention relates to means and methods of collecting blood. More particularly the invention pertains to Means and Methods for collecting cord blood in quantities useful for adult patients requiring stem cell therapy.

### BACKGROUND OF THE INVENTION

### Cord Blood Stem Cells

There is general agreement throughout the medical community that hematopoietic stem cells are increasingly important for therapy. An important and readily available source of stem cells is the umbilical cord blood of neonates. Cord blood is currently used to treat patients who have undergone bone marrow destroying chemotherapy.

At present, however, current techniques of cord blood collection are unable to harvest more than half of the cord blood in the umbilical cord. This places a severe limitation on the usefulness of the current techniques, since the average volumes of Cord Blood collected and Stem Cell quantities extracted there from is only sufficient for a transplant procedure applied to a patient weighing an average of only 34 Kg. The large populations of adults in need of such transplants are thus excluded from this technique, and have to be treated with marrow transplants, which is a medically inferior and more complex procedure.

In current practice, Cord Blood Harvesting techniques fall into the following categories:

### Closed Circuit—Passive Collection Technology.

The Cord Blood Collection method presently in use by all the Private and Public Cord Blood Banks is based on Gravitation—Typically close circuit collection is made into 250 mL donor blood bags with a 16 G needle and 35 mL anti-coagulation solution, either CPD (Citrate Phosphate Dextrose) or Heparin.

The collection carried out by the attending obstetrician or midwife is a 6-15 minutes process. Coagulation of the blood in the cord begins immediately after birth. Due to the bottle-neck of the small diameter needle (about 0.5 mm), inserted to a 2-4 mm diameter vein of the Cord, the collection duration is relatively long. This adversely affects the quality and quantity of the stem cells which are eventually purified from the extracted blood. The average quantity of blood collected is 73 mL, which is insufficient for adult use.

### Closed Circuit—Semi Active Collection Technology.

In this methodology, an anti-coagulation solution is introduced in the upper side of the Cord vein during the collection process, thereby increasing somewhat the collection efficiency.

Studies comparing this method to the Passive Technology method have shown an improvement of 38% from the average of 69 mL of Cord Blood collected by the Passive method to 95 mL.

### Closed Circuit—Active Collection Technology.

This method uses a syringe to perform a flush and drain, withdrawal of cord blood by syringe until delivery of the placenta, followed by flushing through a catheter one of the umbilical arteries with hypotonic sodium chloride solution and collection of the cord blood, either into an open sterile container or into a standard donation blood bag. Similar methods using special machines for the purpose have also been employed. Most or all the blood in the Placenta-Umbilical Cord system can be extracted (174 mL, according to some studies). However, the process is very complicated to conduct. It has been found useful in some research applications, but not practical for employment in Cord Blood Banks.

### Physical Pressure Technology.

With this methodology, in addition to the regular gravity-assisted blood collection technique, pressure is applied to the Placenta, in order to “push” or “squeeze” the blood out of the Placenta. Although more blood is collected—the pressure causes tearing of the blood vessels very easily within the Placenta, resulting in the mixing of the Stem Cells of the newborn with maternal Stem Cells—a major cause of GVHD and death risk to implanted patient. Studies using this method have shown average Cord Blood collection volumes of 88 mL which is an improvement of 44% compared to the average of 61 mL of Cord Blood collected by other methods in this study.

In light of the above it is a long felt unmet need to provide an open circuit method and means for collecting an amount of cord blood suitable for use in an adult recipient.

### SUMMARY OF THE INVENTION

It is object of the invention to disclose a cord blood open circuit collection system (OCCS) comprising:

a. a holder element for enclosing and holding upper un-severed external extremity of an umbilical cord, and;
b. a hermetically closed disinfection compartment in which said held cord is disinfected;
wherein said holder element is adapted to hold said cord over said disinfection compartment, and said holder element is further adapted to reversibly attach to said disinfection compartment, and to allow insertion of the end of said cord into the interior of said disinfection compartment such that when a predetermined length of said umbilical cord is held between said holder element, said disinfection compartment, and the placenta, and said cord is deployed downward vertically from said placenta at a predetermined stage of said collection, said length is thereby optimized for implementation of a predetermined milking protocol of manually applied alternate pulsating pressure waves (APPW) such that high volumes of cord blood are expelled through said cord in a sufficiently rapid manner so as to facilitate collection of at least 100 mL cord blood portion, said portion suitable for use in an adult recipient.

It is a further objective of the invention to disclose the aforementioned cord blood open circuit collection system (OCCS), adapted for use with a milking protocol, said milking protocol comprising the steps of:

a. pressing said cord with the index finger and thumb of one hand so as to exert a pressure sufficient to shut off the blood flow up or down within said cord and to tightly grasp the umbilical cord;
b. pressing said cord with the index finger and thumb of the other hand next bellow of those of the other hand so as to exert a pressure sufficient to shut off the blood flow up or down within said cord;
c. moving said second hand index finger and thumb slowly down the length of said cord from the placenta to said disinfection compartment, thereby causing cord blood to flow down the cord;
d. releasing said two hands index fingers and thumbs from said cord for 540 seconds so as to let blood from the placenta refill the cord vein;
e. repeating steps a through d a sufficient number of times such that a high volume of cord blood is expelled through said cord in a sufficiently rapid manner so to facilitate collection of a volume of cord blood suitable for use in an adult recipient.

It is a further objective of the invention to disclose the aforementioned cord blood open circuit collection system (OCCS), wherein said OCCS is adapted to provide at least 100 mL of harvested cord blood after implementation of said milking protocol.

It is a further objective of the invention to disclose the aforementioned cord blood open circuit collection system (OCCS), wherein said OCCS is adapted to provide harvested cord blood with a TNC of at least 10×10⁸ after implementation of said milking protocol.

It is a further objective of the invention to disclose the aforementioned cord blood open circuit collection system (OCCS), wherein said OCCS is adapted to provide harvested cord blood with a CD34+ content of at least 3.5×10⁶ after implementation of said milking protocol.

It is a further objective of the invention to disclose the aforementioned cord blood open circuit collection system (OCCS), wherein said OCCS is adapted to provide MNC of at least 3×10⁸ after implementation of said milking protocol

It is a further objective of the invention to disclose the aforementioned cord blood open circuit collection system (OCCS), wherein said OCCS is adapted to provide a Cord Blood Volume of at least 100 mL after implementation of said milking protocol

It is a further objective of the invention to disclose the aforementioned cord blood open circuit collection system (OCCS), wherein said OCCS is adapted to provide a Cord Blood with less than 5.25% Maternal Stem Cells in said Cord Blood volume of 100 mL after implementation of said milking protocol

It is a further objective of the invention to disclose the aforementioned cord blood open circuit collection system (OCCS), wherein said OCCS is adapted to provide a Blood Cord Blood Unit containing less than 5.25% of Maternal Stem Cells per unit in less than 15% of said units after implementation of said milking protocol.

It is a further objective of the invention to disclose the aforementioned cord blood open circuit collection system (OCCS), wherein said OCCS is adapted to provide Cord Blood with bacterial and fungal contamination in <5% of the units harvested after implementation of said milking protocol.

It is a further objective of the invention to disclose a method for harvesting cord blood comprising steps of:

obtaining said open circuit collection system (OCCS);
disposing elements of said open circuit collection system in a predetermined configuration about the umbilical cord;
deploying a length of the umbilical cord vertically downward from said placenta at a predetermined stage of said collection;
implementing a predetermined milking protocol of manually applied alternate pulsating pressure waves (APPW).

It is a further objective of the invention to disclose the aforementioned method for harvesting cord blood comprising steps of:

f. pressing said cord with the index finger and thumb of one hand so as to exert a pressure sufficient to shut off the blood flow up or down within said cord and to tightly grasp the umbilical cord;
g. pressing said cord with the index finger and thumb of the other hand next bellow of those of the other hand so as to exert a pressure sufficient to shut off the blood flow up or down within said cord;
h. moving said second hand index finger and thumb slowly down the length of said cord from the placenta to said disinfection compartment, thereby causing cord blood to flow down the cord;
i. releasing said two hands index fingers and thumbs from said cord for 5-10 seconds so as to let blood from the placenta refill the cord vein;
j. repeating steps a through d a sufficient number of times such that a high volume of cord blood is expelled through said cord in a sufficiently rapid manner so to facilitate collection of a volume of cord blood suitable for use in an adult recipient.

It is a further objective of the invention to disclose the aforementioned method for harvesting cord blood comprising steps of adapting said OCCS to provide at least about 100 mL. of harvested cord blood after implementing said milking protocol.

It is a further objective of the invention to disclose the aforementioned method for harvesting cord blood comprising steps of adapting said OCCS to provide harvested cord blood of at least TNC of 10×10⁸ after implementing said milking protocol.

It is a further objective of the invention to disclose the aforementioned method for harvesting cord blood comprising steps of adapting said OCCS to provide harvested cord blood with a CD34+ content of at least 3.5×10⁶ after implementation of said milking protocol

It is a further objective of the invention to disclose the aforementioned method for harvesting cord blood comprising steps of adapting said OCCS to provide MNC of at least 3×10⁸ cells after implementation of said milking protocol

It is a further objective of the invention to disclose the aforementioned method for harvesting cord blood comprising steps of adapting said OCCS to provide a Cord Blood Volume of at least 100 mL after implementation of said milking protocol.

It is a further objective of the invention to disclose the aforementioned method for harvesting cord blood comprising steps of adapting said OCCS to provide harvested Cord Blood with less than 5% Maternal Stem Cells in said Cord Blood Cord Blood volume of at least 100 mL after implementation of said milking protocol

It is a further objective of the invention to disclose the aforementioned method for harvesting cord blood comprising steps of adapting said OCCS to provide a Blood Cord Blood Unit containing less than 5% of Maternal Stem Cells per unit in less than 15% of said units after implementation of said milking protocol.

It is a further objective of the invention to disclose the aforementioned method for harvesting cord blood comprising steps of adapting said OCCS to provide Cord Blood with bacterial and fungal contamination in less than 5% of the units harvested after implementation of said milking protocol

It is a further objective of the invention to disclose the aforementioned method for harvesting cord blood comprising steps of:
obtaining said holder element;
further obtaining said disinfection element;
enclosing said cord with said element;
holding upper un-severed external extremity of said cord;
holding said cord over said disinfection compartment;
reversibly attaching said cord to said disinfection compartment;
inserting said end of said cord into interior of said disinfection compartment;
   wherein said method further comprises steps of disposing said elements in a predetermined configuration, said disposing further comprising:
measuring a predetermined length of the umbilical cord between said attached elements and the placenta;
deploying said length vertically downward from said placenta at a predetermined stage of said collection, thereby optimizing said length for implementing a predetermined milking protocol of manually applied alternate pulsating pressure waves (APPW);
milking said length according to said protocol such that high volumes of cord blood are expelled through said cord sufficiently rapidly as to facilitate collection of at least 100 mL cord blood portion, said portion suitable for use in an adult recipient.

It is a yet further objective of the invention to disclose a kit for collecting a portion of at least 100 mL. of cord blood suitable for use in an adult recipient, said kit comprising:
two-part Situgen assembly said assembly comprising said holder element for enclosing and holding upper un-severed external extremity of said cord and a disinfection element in which said held cord is disinfected;
small syringe (60 mL.) with needle either attached or unattached;
set of cord blood collection syringe (100 mL) connected to needle valve;
container for sampling needle;
CPD or heparin container;
small syringe (60 mL.) with needle either attached or unattached;
disinfectant container;
disinfection means for umbilical cord disinfection;
written instructions;
   wherein said kit is suitable for collecting a portion of at least 100 mL. of cord blood suitable for use in an adult recipient

Lastly, it is a further objective of the invention to disclose the aforementioned kit additionally comprising at least one item selected from a group consisting of disinfecting wipes, scissors, clamping means and cord measuring device.

### DETAILED DESCRIPTION OF EMBODIMENTS OF THE INVENTION

In the following description, various aspects of the invention will be described. For the purpose of explanation, specific configurations and details are set forth in order to provide a thorough understanding of the invention. However, it will also be apparent to one skilled in the art that the invention may be practiced without specific details, such as those presented herein. Furthermore, well-known features may be omitted or simplified in order not to obscure the invention.

### DEFINITION OF TERMS AND ABBREVIATIONS

Antibodies—Antibodies (also known as immunoglobulins) are proteins found in blood or other bodily fluids of vertebrates, and are used by the immune system to identify and neutralize foreign substances and particles, such as bacteria and viruses.

Antigen—An antigen or immunogen is a molecule that stimulates an immune response.

Bone Marrow (BM)—the soft tissue found in the hollow interior of bones.

Cellular Therapy—describes the process of introducing new cells into a tissue in order to treat a disease. Cell therapies often focus on the treatment of hereditary diseases, with or without the addition of gene therapy (also see Regenerative Medicine and Gene Therapy)

Cord Blood (CB)—human blood from the placenta and umbilical cord.

Cord Blood Bank (CBB)—a facility which stores umbilical cord blood for future use. Cord blood, a precious resource physiologically transfused from the placenta through the umbilical cord to the neonate for stabilization upon birth is not usually collected by prior art methods in sufficient quantities to be useful to adult recipients.

### Cord Blood Stem Cells (CBSC).

CD34+—a cluster of differentiation molecule present on certain cells within the human body. It is a cell surface glycoprotein and functions as a cell-cell adhesion factor.

The number of CD34+ cells or the number of TNC (Total Nucleated Cells)—are the main accepted parameters with respect to the quality and efficacy of Stem Cells Transplantations. The average number of TNC in Cord Blood as measured by numerous studies is in the range 7-9×10⁸ cells/mL.

A good correlation has been identified among the following parameters:

Blood volume, TNC, and CD34+
The average range of CD34+ is 3-3.5×10⁶ molecules/cell
MNC—mono nucleated cells.
HLA—human leukocyte antigen, also known as human major histo-compatibility complex (MHC). This group of genes resides on chromosome 6, encoding cell-surface antigen-presenting and other proteins.

Reference is now made to a cord blood open circuit collection system (OCCS) comprising:

k. An element for enclosing and holding upper un-severed external extremity of said cord;
l. a hermetically closed disinfection compartment in which said held cord is disinfected;
m. said holder element adapted to hold said cord over said disinfection compartment, said holder element further adapted to reversibly attach to said disinfection compartment, said holder further adapted to insert said end of said cord into interior of said disinfection compartment; and
n. a means for disposing said elements in a predetermined configuration wherein said predetermined configuration is characterized in that a predetermined length of the umbilical cord between said attached elements and the placenta deploys vertically downward from said placenta at a predetermined stage of said collection, said length thereby optimized for implementation of a predetermined milking protocol of manually applied alternate pulsating pressure waves (APPW) such that high volumes of cord blood are expelled through said cord sufficiently rapidly as to facilitate collection of at least 100 mL cord blood portion, said portion suitable for use to transplant an adult recipient.

Reference is now made to a cord blood open circuit collection system (OCCS) wherein said OCCS is adapted for use with said milking protocol, further wherein said milking protocol comprises steps of:

A. pressing said cord with the index finger and thumb of one hand so as to exert a pressure sufficient to shut off the blood flow up or down within said cord and to tightly grasp the umbilical cord;
B. pressing said cord with the index finger and thumb of the other hand next bellow of those of the other hand so as to exert a pressure sufficient to shut off the blood flow up or down within said cord;
C. moving said second hand index finger and thumb slowly down the length of said cord from the placenta to said disinfection compartment, thereby causing cord blood to flow down the cord;
D. releasing said two hands index fingers and thumbs from said cord for 5-10 seconds so as to let blood from the placenta refill the cord vein;
E. repeating steps A through D a sufficient number of times such that a high volume of cord blood is expelled through said cord in a sufficiently rapid manner so to facilitate collection of a volume of cord blood suitable for use in an adult recipient.

Reference is now made to a cord blood open circuit collection system (OCCS) wherein said OCCS is adapted to provide at least 100 mL of harvested cord blood after implementation of said milking protocol.

Reference is now made to a cord blood open circuit collection system (OCCS) wherein said OCCS is adapted to provide harvested cord blood with a TNC of at least 10×10⁸ after implementation of said milking protocol.

Reference is now made to a cord blood open circuit collection system (OCCS) wherein said OCCS is adapted to provide harvested cord blood with a CD34+ content of at least 3.5×10⁶ after implementation of said milking protocol.

Reference is now made to a cord blood open circuit collection system (OCCS) wherein said OCCS is adapted to provide MNC of at least 3×10⁸ after implementation of said milking protocol.

Reference is now made to a cord blood open circuit collection system (OCCS) wherein said OCCS is adapted to provide a Cord Blood Volume of at least 100 mL after implementation of said milking protocol.

Reference is now made to a cord blood open circuit collection system (OCCS) wherein said OCCS is adapted to provide a Cord Blood with less than 5.25% Maternal Stem Cells in said Cord Blood volume of 100 mL after implementation of said milking protocol.

Reference is now made to a cord blood open circuit collection system (OCCS) wherein said OCCS is adapted to provide a Blood Cord Blood Unit containing less than 5.25% of Maternal Stem Cells per unit in less than 15% of said units after implementation of said milking protocol.

Reference is now made to a cord blood open circuit collection system (OCCS) wherein said OCCS is adapted to provide Cord Blood with bacterial and fungal contamination in <5% of the units harvested after implementation of said milking protocol.

Reference is now made to a method for harvesting cord blood comprising steps of:

obtaining said open circuit collection system (OCCS);
disposing elements of said open circuit collection system in a predetermined configuration about the umbilical cord;
deploying a length of the umbilical cord vertically downward from said placenta at a predetermined stage of said collection;
implementing a predetermined milking protocol of manually applied alternate pulsating pressure waves (APPW).

Reference is now made to a method for harvesting cord blood comprising steps:

o. pressing said cord with the index finger and thumb of one hand so as to exert a pressure sufficient to shut off the blood flow up or down within said cord and to tightly grasp the umbilical cord;
p. pressing said cord with the index finger and thumb of the other hand next bellow of those of the other hand so as to exert a pressure sufficient to shut off the blood flow up or down within said cord;
q. moving said second hand index finger and thumb slowly down the length of said cord from the placenta to said disinfection compartment, thereby causing cord blood to flow down the cord;
r. releasing said two hands index fingers and thumbs from said cord for 5-10 seconds so as to let blood from the placenta refill the cord vein;
s. repeating steps a through d a sufficient number of times such that a high volume of cord blood is expelled through said cord in a sufficiently rapid manner so to facilitate collection of a volume of cord blood suitable for use in an adult recipient.

Reference is now made to a method for harvesting cord blood comprising steps of adapting said OCCS to provide at least about 100 mL. of harvested cord blood after implementing said milking protocol.

Reference is now made to a method for harvesting cord blood comprising steps of adapting said OCCS to provide harvested cord blood of at least TNC of 10×10⁸ after implementing said milking protocol.

Reference is now made to a method for harvesting cord blood comprising steps of adapting said OCCS to provide harvested cord blood with a CD34+ content of at least 3.5×10⁶ after implementation of said milking protocol.

Reference is now made to a method for harvesting cord blood comprising steps of adapting said OCCS to provide MNC of at least 3×10⁸ cells after implementation of said milking protocol.

Reference is now made to a method for harvesting cord blood comprising steps of adapting said OCCS to provide a Cord Blood Volume of at least 100 mL after implementation of said milking protocol.

Reference is now made to a method for harvesting cord blood comprising steps of adapting said OCCS to provide harvested Cord Blood with less than 5% Maternal Stem Cells in said Cord Blood Cord Blood volume of at least 100 mL after implementation of said milking protocol.

Reference is now made to a method for harvesting cord blood comprising steps of adapting said OCCS to provide a Blood Cord Blood Unit containing less than 5% of Maternal Stem Cells per unit in less than 15% of said units after implementation of said milking protocol.

Reference is now made to a method for harvesting cord blood comprising steps of adapting said OCCS to provide Cord Blood with bacterial and fungal contamination in less than 5% of the units harvested after implementation of said milking protocol.

Reference is now made to a method for harvesting cord blood comprising steps of:
obtaining said holder element;
further obtaining said disinfection element;
enclosing said cord with said element;
holding upper un-severed external extremity of said cord;
holding said cord over said disinfection compartment;
reversibly attaching said cord to said disinfection compartment;
inserting said end of said cord into interior of said disinfection compartment;
   wherein said method further comprises steps of disposing said elements in a predetermined configuration, said disposing further comprising:
measuring a predetermined length of the umbilical cord between said attached elements and the placenta;
deploying said length vertically downward from said placenta at a predetermined stage of said collection, thereby optimizing said length for implementing a predetermined milking protocol of manually applied alternate pulsating pressure waves (APPW);
milking said length according to said protocol such that high volumes of cord blood are expelled through said cord sufficiently rapidly as to facilitate collection of at least 100 mL cord blood portion, said portion suitable for use in an adult recipient.

Reference is now made to a kit for collecting a portion of at least 100 mL. of cord blood suitable for use in an adult recipient, said kit comprising:
two-part Situgen assembly said assembly comprising said holder element for enclosing and holding upper un-severed external extremity of said cord and a disinfection element in which said held cord is disinfected;
small syringe (60 mL.) with needle either attached or unattached;
set of cord blood collection syringe (100 mL) connected to needle valve;
container for sampling needle;
heparin container;
small syringe (60 mL.) with needle either attached or unattached;
disinfectant container;
disinfection means for umbilical cord disinfection;
written instructions;
   wherein said kit is suitable for collecting a portion of at least 100 mL. of cord blood suitable for use in an adult recipient.

Lastly, reference is made to the aforementioned kit additionally comprising at least one item selected from a group consisting of disinfecting wipes, scissors, clamping means and cord measuring device.

A preferred embodiment of the invention is described below in terms of a manual of instructions for collecting cord blood. This should be regarded as non-limiting. It is acknowledged herein that variations of the instructions and other embodiments of the invention may occur to a person skilled in the art and these are well within the scope and claims of the present invention.

### Example

### Introduction

The collection of umbilical cord blood by means of the Situgen blood collection device and system is carried out in 3 stages:

### Stage 1: Pre-Birth

Stage 2: Collection of cord blood
Stage 3: Preparation for dispatch to blood bank

### Components of the Situgen Kit

### 1. Preparation for Delivery

### A. Preparation of the Work Surface

1. Prepare the working surface under the mother.

2. Disinfect the working surface with alcohol.

3. Place the SituGen kit next to the working surface.

4. Open the upper cover of the main case and make sure that the kit is in working order and its contents are complete.

5. Place the white absorbent paper towel above the working surface.

6. Place this user guide near the SituGen kit.

B. Preparation of Receptacle/Surface for Placing the Placenta after it Expels

7. Prepare the surface for accommodating the placenta from the work surface, in case the placenta is expelled during cord blood collection.

8. Disinfect the work surface and the receptacle.

9. Place the green paper towel on the receptacle.

Content of the Collecting Kit

| Package #1 (SituKit) | | | | | | | | | | | |
|---|---|---|---|---|---|---|---|---|---|---|---|
| | | | | | | Compartment III | | | | | |
| Compartment I | | | Compartment II | | | Accessory and | | | | | |
| Assisting items | | | Disinfecting items | | | collection items | | | Package #2 | | |
| # | Item | Qty | # | Item | Qty | # | Item | Qty | # | Item | Qty |
| 1 | White | 1 | 1 | Large | 2 | 2 | SituGen aid | 1 | 1 | SituGen | |
| | absorbing | | | preps for | | | Syringe | | | device - two | |
| | paper | | | disinfecting | | | (empty, | | | parts of the | |
| | towel | | | the | | | without | | | SituGen | |
| | | | | umbilical | | | valve) | | | accessory | |
| | | | | cord | | | | | | (the bottom | |
| 2 | Green | 1 | 2 | Syringe | 1 | 3 | Blood | 1 | | of the | |
| | non- | | | with | | | collection bag | | | collection | |
| | absorbing | | | disinfecting | | | (350 mL) with | | | compartment | |
| | paper | | | solution | | | anticoagulant | | | has a valve | |
| | towel | | | | | | connected to | | | and a | |
| | | | | | | | a valve | | | connection | |
| 3 | Umbilical | 2 | 3 | Small | 4 | 4 | Needle for | 1 | | controller | |
| | damp | | | preps for | | | collecting | | | installed) | |
| | scissors | | | disinfecting | | | blood | | | | |
| | (re- | | | the | | | straight from | | | | |
| | openable) | | | placenta | | | the placenta | | | | |
| | | | | | | | after | | | | |
| | | | | | | | collection in | | | | |
| | | | | | | | the accessory | | | | |
| 4 | Scissors | 1 | | | | 5 | Plastic zip- | 1 | | | |
| | for cutting | | | | | | lock bag for | | | | |
| | the | | | | | | dispatching | | | | |
| | umbilical | | | | | | the collection | | | | |
| | cord | | | | | | bag | | | | |
| 5 | Ruler for | 1 | | | | 6 | Plastic bag | | | | |
| | measuring | | | | | | for | | | | |
| | the length | | | | | | dispatching | | | | |
| | of the | | | | | | the placenta | | | | |
| | umbilical | | | | | | blood syringe | | | | |
| | cord | | | | | | to the | | | | |
| | residual | | | | | | laboratory | | | | |

### Collecting the Umbilical Cord Blood

A. Preparation of the Situgen Device—after the Initiation of the Delivery

1. Carefully open the two parts of the SituGen device (Compartment number 3).

2. Open the hanging hook of the device.

3. Ensure that the filter cap on the device right hand side has been removed.

### B. Preparation of the Umbilical Cord

1. Immediately after the delivery of the infant and clamping of the umbilicus on the infant side (with a regular hospital clamp), clamp the cord using the clamping scissors, about 2 cm from the infant's clamp.

2. Cut the umbilical cord between the two clamps sing the cutting scissors.

3. Hold the bottom end of the umbilical cord. Measure 11 cm from the lower clamping scissors using the measuring ruler.

4. Drain the blood in the umbilical cord by milking it from the clamping scissors towards the placenta.

5. Hold the umbilical cord in order to prevent blood reflux and clamp above the drained area using the additional clamping scissors.

6. Remove the lower clamping scissors from the cord.

7. Carefully wipe the umbilical cord under the upper clamping scissors using the two large disinfecting preps, for complete removal of maternal stem cells.

### C. Connection of the Umbilical Cord to the Situgen Device

1. Place the two parts of the SituGen device—the guide and the body—on the work surface, with the UP marking facing the patient.

2. Place the end of the umbilical cord in one of the guide channels in an open position, with the clamping scissors adjacent to the guide.

3. Fix the clamping scissors with the pin at the top of the guide.

4. Close the guide with the umbilical cord inside it and the end of the cord protruding from the bottom of the guide.

5. To connect the two parts of the device, insert the end of the umbilical cord protruding from the guide into the device body. Insert the cord through the stop device body into the clean compartment until the guide touches the upper surface of the device body. Make sure that the end of the cord appears in the clean compartment, if necessary you can use your little finger to help it.

6. Lock the guide to the device body by turning the guide in the direction of the Close arrow until it engages in the teeth of the device body.

### D. Disinfecting the Clean Compartment Before Collection

1. Slightly loosen the clamping scissors until a few blood drops enter the clean compartment and retighten.

2. Connect the syringe with disinfection solution to the connector at the bottom of the device and inject solution until the clean compartment is filled and a few drops of solution exit from the filter.

3. Wait for about 10 seconds with the syringe connected to the device.

4. Drain all of the disinfectant solution back into the same syringe.

5. Disconnect the syringe from the Luer connector and discard the syringe.

6. Seal the filter in the device using the cap to prevent air entry.

E. Collecting the Blood from the Umbilical Cord

1. Connect the collection bag (350 mL) to the connection controller into the valve at the bottom of the device.

2. Position and hang the device under the patient. Ensure that the umbilical cord is loose.

3. Open the clamping scissors and release from the pin holding them.

4. Let the blood flow into the clean, bottom compartment.

5. Every few seconds, drain the umbilical cord throughout its length, by milking it up (Placenta) to down (device).

6. Only in case quicker drainage is needed from the compartment to the bag—remove the filter cap on the right hand side, connect the aiding Syringe (without a valve) when the syringe handle is fully pulled out and slowly push it down.

7. Continue to collect until full extraction of blood. Every drop is important.

F. Collecting the Blood from the Placenta.

1. Once collection from the umbilical cord is over, wait for the placenta to be expelled, check if there's any blood available and if so switch to collecting the blood remaining in the placenta.

2. Identify the blood-rich veins in the placenta (on the umbilical cord exit side); full veins protrude more.

3. Connect the needle to the syringe containing anticoagulant, connected to a valve.

4. Disinfect the vein using one of the small preps.

5. Collect all of the blood from each of the full veins until complete drainage of blood from the placenta.

### 3. Preparation and Dispatch to the Laboratory

1. Carefully shake the collection bag and the placenta syringe that have been filled with blood.

2. Pack the collection bag in the zip-lock bag and the placenta blood syringe in the syringe dispatch bag.

3. Insert the packed bag and syringe into the delivery box.

4. Transfer the delivery box with the syringes containing the umbilical blood to the laboratory using a courier as quickly as possible.

### Milking Protocol:

1. pressing said cord with the index finger and thumb of one hand so as to exert a pressure sufficient to shut off the blood flow up or down within said cord and to tightly grasp the umbilical cord;

2. pressing said cord with the index finger and thumb of the other hand next below those of the other hand so as to exert a pressure sufficient to shut off the blood flow up or down within said cord;

3. moving said second hand index finger and thumb slowly down the length of said cord from the placenta to said disinfection compartment, thereby causing cord blood to flow down the cord;

4. releasing said two hands index fingers and thumbs from said cord for 5-10 seconds so as to let blood from the placenta refill the cord vein;

5. repeating steps 1 through 4 a sufficient number of times such that a high volume of cord blood is expelled through said cord in a sufficiently rapid manner so to facilitate collection of a volume of cord blood suitable for use in an adult recipient.

Note that the technique requires pressing all along the visible cord, between the placenta (UP) and the device (DOWN)

While a number of exemplary aspects and embodiments have been discussed above, those of skill in the art will recognize certain modifications, permutations, additions and sub-combinations thereof. It is therefore intended that the following appended claim as and claims hereafter introduced be interpreted to include all such modifications, permutations, additions and sub-combinations as are within their scope.

1. A cord blood open circuit collection system (OCCS) comprising;
a. a holder element for enclosing and holding upper un-severed external extremity of an umbilical cord, and;
b. a hermetically closed disinfection compartment in which said held cord is disinfected;
wherein said holder element is adapted to hold said cord over said disinfection compartment, and said holder element is further adapted to reversibly attach to said disinfection compartment, and to allow insertion of the end of said cord into the interior of said disinfection compartment such that when a predetermined length of said umbilical cord is held between said holder element, said disinfection compartment, and the placenta, and said cord is deployed downward vertically from said placenta at a predetermined stage of said collection, said length is thereby optimized for implementation of a predetermined milking protocol of manually applied alternate pulsating pressure waves (APPW) such that high volumes of cord blood are expelled through said cord in a sufficiently rapid manner so as to facilitate collection of at least 100 mL cord blood portion, said portion suitable for use in an adult recipient.

2. The OCCS according to claim 1, adapted for use with a milking protocol, said milking protocol comprising the steps of;
a. pressing said cord with the index finger and thumb of one hand so as to exert a pressure sufficient to shut off the blood flow up or down within said cord and to tightly grasp the umbilical cord;
b. pressing said cord with the index finger and thumb of the other hand next bellow of those of the other hand so as to exert a pressure sufficient to shut off the blood flow up or down within said cord;
c. moving said second hand index finger and thumb slowly down the length of said cord from the placenta to said disinfection compartment, thereby causing cord blood to flow down the cord;
d. releasing said two hands index fingers and thumbs from said cord for 5-10 seconds so as to let blood from the placenta refill the cord vein;
e. repeating steps a through d a sufficient number of times such that a high volume of cord blood is expelled through said cord in a sufficiently rapid manner so to facilitate collection of a volume of cord blood suitable for use in an adult recipient.

3. The OCCS according to claim 2, adapted to provide at least 100 mL. of harvested cord blood after implementation of said milking protocol.

4. The OCCS according to claim 2, adapted to provide harvested cord blood with a TNC of at least 10×10⁸ after implementation of said milking protocol.

5. The OCCS according to claim 2, adapted to provide harvested cord blood with a CD34+ content of at least 3.5×10⁶ after implementation of said milking protocol.

6. The OCCS according to claim 2, adapted to provide MNC of at least 3×10⁸ after implementation of said milking protocol.

7. The OCCS according to claim 2, adapted to provide a Cord Blood Volume of at least 100 mL after implementation of said milking protocol.

8. The OCCS according to claim 2, adapted to provide a Cord Blood with less than 5.25% Maternal Stem Cells in said Cord Blood volume of 100 mL after implementation of said milking protocol.

9. The OCCS according to claim 2, adapted to provide a Blood Cord Blood Unit containing less than 5.25% of Maternal Stem Cells per unit in less than 15% of aid units after implementation of said milking protocol.

10. The OCCS according to claim 2 adapted to provide Cord Blood with bacterial and fungal contamination in <5% of the units harvested after implementation of said milking protocol.

11. A method for harvesting cord blood, comprising steps of:
a. obtaining said open circuit collection system (OCCS), said OCCS comprising;
i. a holder element for enclosing and holding upper un-severed external extremity of an umbilical cord, and;
ii. a hermetically closed disinfection compartment in which said held cord is disinfected;
wherein said holder element is adapted to hold said cord over said disinfection compartment, and said holder element is further adapted to reversibly attach to said disinfection compartment, and to allow insertion of the end of said cord into the interior of said disinfection compartment;
b. disposing said holder element and said disinfection compartment in a predetermined configuration about the umbilical cord;
c. deploying a length of the umbilical cord vertically downward from the placenta and implementing a predetermined milking protocol of manually applied alternate pulsating pressure waves (APPW).

12. The method according to claim 11, wherein said milking protocol comprises the steps of:
a. pressing said cord with the index finger and thumb of one hand so as to exert a pressure sufficient to shut off the blood flow up or down within said cord and to tightly grasp the umbilical cord;
b. pressing said cord with the index finger and thumb of the other hand next bellow of those of the other hand so as to exert a pressure sufficient to shut off the blood flow up or down within said cord;
c. moving said second hand index finger and thumb slowly down the length of said cord from the placenta to said disinfection compartment, thereby causing cord blood to flow down the cord;
d. releasing said two hands index fingers and thumbs from said cord for 5-10 seconds so as to let blood from the placenta refill the cord vein;
e. repeating steps a through d a sufficient number of times such that a high volume of cord blood is expelled through said cord in a sufficiently rapid manner so to facilitate collection of a volume of cord blood suitable for use in an adult recipient.

13. The method according to claim 12, adapted for providing at least 100 mL. of harvested cord blood after implementation of said milking protocol.

14. The method according to claim 12, adapted for providing at least about 100 mL. of harvested cord blood after implementing said milking protocol.

15. The method according to claim 12, adapted for providing harvested cord blood of at least TNC of 10×10⁸ after implementing said milking protocol.

16. The method according to claim 12, adapted for providing harvested cord blood with a CD34+ content of at least 3×10⁶ molecules/cell after implementation of said milking protocol.

17. The method according to claim 12, adapted for providing a MNC of at least 3×10⁸ cells after implementation of said milking protocol.

18. The method according to claim 12, adapted for providing a Cord Blood Volume of at least 100 mL after implementation of said milking protocol.

19. The method according to claim 12, adapted for providing harvested Cord Blood with less than 5% Maternal Stem Cells in said Cord Blood Cord Blood volume of at least 100 mL after implementation of said milking protocol.

20. The method according to claim 12, adapted for providing Blood Cord Blood Unit containing less than 5% of Maternal Stem Cells per unit in less than 15% of said units after implementation of said milking protocol.

21. The method according to claim 12, adapted for providing Cord Blood with bacterial and fungal contamination in less than 5% of the units harvested after implementation of said milking protocol.

22. A method for collecting at least 100 mL. of cord blood suitable for use in an adult recipient, said method comprising steps of
a. obtaining a holder element;
b. obtaining a disinfection element wherein said holder element is adapted to hold said cord over said disinfection compartment, and said holder element is further adapted to reversibly attach to said disinfection compartment, and to allow insertion of the end of said cord into the interior of said disinfection compartment;
c. enclosing an umbilical cord with said holder element;
d. holding the upper un-severed external extremity of said cord;
e. holding said cord over said disinfection compartment;
f. reversibly attaching said cord to said disinfection compartment;
g. inserting the end of said cord into interior of said disinfection compartment wherein said method further comprises steps of disposing said elements in a predetermined configuration, said disposing further comprising;
i. measuring a predetermined length of the umbilical cord between said holder element, said disinfection element and the placenta;
ii. deploying said length of cord vertically downward from said placenta at a predetermined stage of said collection, thereby optimizing said length for implementing a predetermined milking protocol of manually applied alternate pulsating pressure waves (APPW);
iii. milking said length according to said protocol such that a high volume of cord blood is expelled through said cord in a manner sufficiently rapid so as to facilitate collection of at least 100 mL cord blood portion, said portion suitable for use in an adult recipient.

23. A kit for collecting a portion of at least 100 mL. of cord blood suitable for use in an adult recipient, said kit comprising:
a. a two-part Situgen assembly comprising a holder element for enclosing and holding the upper un-severed external extremity of an umbilical cord and a disinfection element in which said cord is disinfected;
b. a small syringe, optionally having an attached needle;
c. a set of cord blood collection syringe(s) (100 mL.) connected to a needle valve;
d. a container for sampling needle;
e. a heparin container;
f. small syringe optionally having an attached needle;
g. disinfection means for disinfection of the umbilical cord;
wherein said kit is suitable for collecting a portion of at least 100 mL. of cord blood suitable for use in an adult recipient.

24. A kit according to claim 23, additionally comprising at least one component selected from a group consisting of disinfecting wipes, scissors, clamping means and cord measuring devices.
